(19) United States
(12) Patent Application Publication
(10) Pub. No.: US 2025/0134748 A1
(43) Pub. Date: May 1, 2025

(54) Lower Body Gait Rehabilitation Harness

(71) Applicants: Andrew J.D. Burns, Bend, OR (US); Richard S. Burns, Phoenix, AZ (US)

(72) Inventors: Andrew J.D. Burns, Bend, OR (US); Richard S. Burns, Phoenix, AZ (US)

(21) Appl. No.: 18/932,126

(22) Filed: Oct. 30, 2024

Related U.S. Application Data
(60) Provisional application No. 63/594,265, filed on Oct. 30, 2023.

(51) Int. Cl. A61H 3/00

(52) U.S. Cl. CPC A61H 3/008

(57) ABSTRACT

A harness includes an inelastic waist belt having a rear, a left side, an opposed right side, and opposed left and right front ends configured to couple to each other. First and second hip plate assemblies are connected to the waist belt and extend therefrom. Each of the first and second hip plate assemblies includes a plate a block located centrally on the plate, and a cable connection on the block. First and second thigh sleeve assemblies are connected to the first and second hip plate assemblies, respectively, and extend therefrom.

### CROSS-REFERENCE TO RELATED APPLICATIONS

This application claims the benefit of U.S. Provisional Application No. 63/594,265, filed Oct. 30, 2023, which is hereby incorporated by reference in its entirety.

### FIELD

The present specification relates generally to locomotive equipment, and more particularly to harnesses for use in locomotive rehabilitation, therapy, and training equipment.

### BACKGROUND

Locomotion is a basic facet of human life. Mobility can, however, be difficult, injurious, or impossible for some. There are a variety of reasons why a person may experience partial or complete mobility limitations: orthopedic conditions, neurological disorders, motor deconditioning, accident, injury, disease, and disability, for example. Continuing to move—or even attempting to move—can cause discomfort or injury.

Others may be injured or overweight but require exercise to become healthier. Some rehabilitation facilities have elaborate systems to partially support the weight of such patients, so that they may exercise toward health. The patients wear harnesses that are tethered to trolleys which ride in tracks in the ceiling. Such systems are complex, require assistance from a physical therapist, and are very expensive and thus limited in availability to the patient. Some of these systems provide a lifting force by spring, which changes as the user moves and displaces the spring. Others have sophisticated sensing technology which monitors movement of the patient and then adjusts the lifting force so as to provide a constant unweighting of the patient.

In some cases, movement may be possible and, indeed, easy, but the individual nonetheless wishes to lower his risk of injury from such movement. Athletes, for instance, often have a need to train long hours with great intensity. They balance the benefits of high-volume training against the elevated risk of injury. A competitive athlete can, after all, suffer serious physical and mental setbacks from even a mild injury. There are a variety of assistive devices to reduce the likelihood of injury during exercise. For example, runners may use buoyancy devices and run in the water. Or they may run on treadmills while zipped into a pressurized bag that lifts them slightly off the treadmill deck, thereby reducing foot-strike impact.

Still other people do not require assistance reducing their effective bodyweight but do need help with posture and/or stabilization. For them, leaning or tilting beyond the line of gravity can create a dangerous loss of balance.

Physical therapists often have other devices which suspend from above to support the user while he or she moves. For example, devices exist which can be placed over or above a treadmill, usually with harnesses, hooks, or special clothing that partially lifts the patient while walking or running on a treadmill. These devices apply an upward force on a patient to reduce his impact while moving.

Of course, all of these solutions lack freedom of movement. The user is confined to a pool, a treadmill, or a pre-defined path set in ceiling tracks. The person cannot use any of these to walk to the bathroom or around the neighborhood, for example.

Further, and more seriously, each alters the normal pattern of motion during walking and running. Harnesses that hang from ceiling tracks generally support the user at a single location, usually above the head or near the center of the back. Occasionally they lift the user at opposed sides of the hips. In both arrangements, the harness restricts the normal movement of the upper body during locomotion. The user may experience upward lift on one side of his body that is the same as that on the other side of this body. In other words, the user's left and right sides are lifted equally and simultaneously. In normal walking and running, however, the forces along the left side of the body are different than and independent from those along the right side of the body. Such systems do not account for these differences, and may exercise different muscles than those used in normal running and walking, thereby leading to improper or prolonged rehabilitation, therapy, or training.

Moreover, these systems may exercise different muscles than those used in normal walking and running, thereby leading to improper or prolonged rehabilitation, therapy, or training. The use of these devices in rehabilitation, therapy, or training fails to mimic real-life movement and may lead to improper recovery. One critical factor in the failures of conventional devices is the designs of the harnesses that connect the person to the device.

Specialized harnesses designed to support and facilitate natural movement patterns are essential for gait training and upright walking in rehabilitation. Ideally, harnesses should not restrict natural movements. In reality, conventional harnesses do just the opposite.

There are a variety of lower body harnesses designed to lift the body, and for a variety of purposes. For example, there are harnesses for climbing, acrobatics, gymnastics, hang gliding, theater, stunt work, etc. Each of these is designed for supporting the user vertically in a partial or full sitting posture by providing support at the level of the ischial tuberosities, or “sit bones”, and upper thighs.

These harnesses present problems when adapted to locomotion. Some are not designed for horizontal movement such as walking and thus may increase the risk of falls. Moreover, if the user does fall, the harness may not adequately support their weight, or it may shift their weight when the user moves unexpectedly, thereby causing the user to lose their balance and fall.

Most harnesses do not provide the necessary support to the pelvis for gait training, which leads to inefficient or improper gait patterns, which reduces the effectiveness of rehabilitation. Many harnesses distribute weight improperly across the lower body when used during walking. This can cause instability and increase the likelihood of developing compensatory gait patterns that could actually worsen existing mobility issues.

Many harnesses require an extremely tight fit for their specialized purposes. Climbing or lifting harnesses, for example, focus on weight distribution around the hips, groin, and thighs. This can create uncomfortable pressure points when used for walking. In some situations, it can compress nerves, leading to numbness, tingling, or even long-term nerve damage is used inappropriately for extensive time periods.

Range of motion is also an issue with some harnesses. Any design that limits the range of motion in the hips,—hip flexion, abduction, and adduction—will hinder natural walking patterns. This impedes proper gait mechanics, impacts productive and effective rehabilitation, and can actually cause further injury in lower back, hips, legs, or elsewhere. Moreover, because the attachment points on climbing or lifting harnesses are usually on the front, attaching to a supportive cable can actually pull the user forward slightly, disrupting the natural upright posture that is needed for proper walking and leading to a forward-leaning gait that can increase the risk of falls or strain on the lower back.

Lastly, because many conventional harnesses are uncomfortable and awkward to wear, and because they can cause instability during, many users develop fear and anxiety during walking exercises. This is, of course, counterproductive to rehabilitation; the user may actually become hesitant to return to rehab and engage in the necessary gait training, thereby slowing down or potentially even halting recovery.

There is a need for a harness which is effective for its intended purpose, designed for horizontal walking without discomfort, restricted movement, altered posture, inadequate support, increased injury risk, and negative psychological effects. For gait training and upright walking, there is a need for an improved harness.

### SUMMARY

In an embodiment, a harness includes an inelastic waist belt having a rear, a left side, an opposed right side, and opposed left and right front ends configured to couple to each other. First and second hip plate assemblies are connected to the waist belt and extend therefrom. Each of the first and second hip plate assemblies includes a plate, a block located centrally on the plate, and a cable connection on the block. First and second thigh sleeve assemblies are connected to the first and second hip plate assemblies, respectively, and extend therefrom.

In an embodiment, a harness includes an inelastic waist belt having a rear, a left side, an opposed right side, and opposed left and right front ends configured to couple to each other. First and second hip plate assemblies are connected to the waist belt and extend therefrom. First and second thigh sleeve assemblies are connected to the first and second hip plate assemblies, respectively, and extend therefrom, wherein each of the first and second thigh sleeve assemblies includes a continuous sleeve constructed of inelastic and elastic material having a height and a circumference, a plurality of inelastic segments spaced apart along the height of the sleeve, and an adjustable pulley assembly carried on the sleeve and threaded among the inelastic segments.

In an embodiment, a harness includes an inelastic waist belt having a rear, a left side, an opposed right side, and opposed left and right front ends configured to couple to each other. First and second hip plate assemblies are connected to the waist belt and extending therefrom, wherein each of the first and second hip plate assemblies includes a plate, the plate having a front and an opposed rear, a top and an opposed bottom, a front slot at the front, a rear slot at the rear, and a bottom slot at the bottom, a block located centrally on the plate between the front, rear, top, and bottom, a cable connection on the block, and first and second thigh sleeve assemblies connected to the first and second hip plate assemblies, respectively, and extending therefrom. Each of the first and second thigh sleeve assemblies includes a continuous sleeve constructed of inelastic and elastic material having a height and a circumference, a plurality of inelastic segments spaced apart along the height of the sleeve, and an adjustable pulley assembly carried on the sleeve and threaded among the inelastic segments. The waist belt passes through the front and rear slots of the first and second hip plate assemblies, a first vertical belt couples the first hip plate assembly to the first thigh sleeve assembly, and a second vertical belt couples the second hip plate assembly to the second thigh sleeve assembly.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIGS. 1 and 2 are front and rear perspectives, respectively, of a lower body gait rehabilitation harness;

FIG. 3 is a left side view of a portion of the lower body gait rehabilitation harness of FIG. 1, including a waist belt, a hip plate assembly, and a thigh sleeve assembly;

FIG. 4 is an enlarged left side view of the hip plate assembly and waist belt of FIG. 3;

FIG. 5A is a perspective view of an embodiment of a cable connection for use in a lower body gait rehabilitation harness;

FIG. 5B is an exploded perspective view of the cable connection of FIG. 5A; and

FIG. 6 is a perspective view of an embodiment of a hip plate for use in a lower body gait rehabilitation harness.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

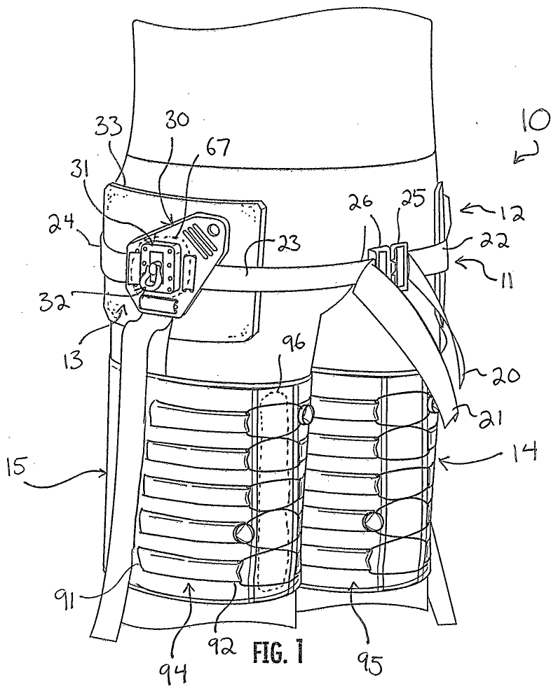

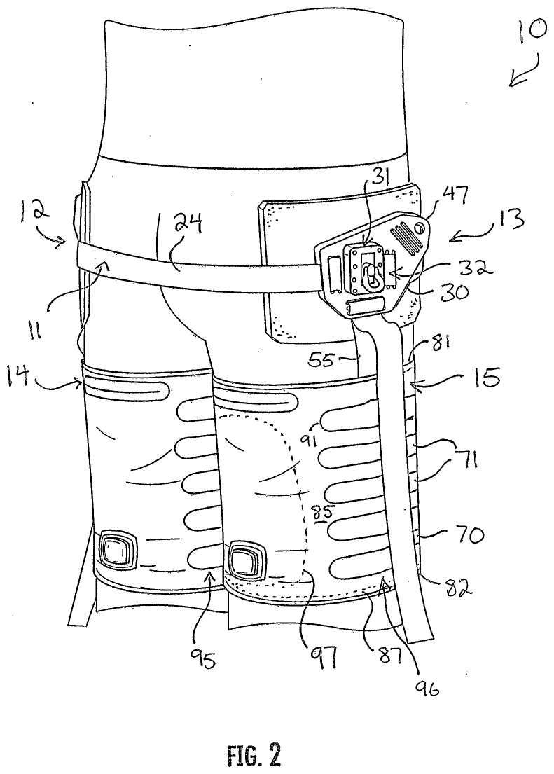

FIGS. 1 and 2 are front and rear perspective views of a lower body gait rehabilitation harness 10 (hereinafter, “harness 10”) worn by a user for use with a body weight support device for locomotion and rehabilitation. The harness 10 includes a waist belt 11, left and right hip plate assemblies 12 and 13 coupled to the waist belt, and left and right thigh sleeve assemblies 14 and 15 coupled to the left and right hip plate assemblies 12 and 13, respectively.

The waist belt 11 is constructed from an inelastic material, such as webbing. The waist belt 11 is a single length of material, having two opposite ends, one defining a left front end 20 and the other defining a right front end 21. The waist belt 11 extends back from the front ends 20 and 21 along a left side 22 and a right side 23, meeting at a rear 24 of the waist belt 11.

The waist belt 11 has a constant thickness and a constant height between opposed upper and lower edges. A buckle allows the waist belt 11 to be wrapped and closed in a loop. The buckle has a left buckle portion 25 and a right buckle portion 26 which couple to each other to form the buckle and to couple the opposed left and right front ends 20 and 21 to each other.

The buckle portions 25 and 26 slide along the waist belt 11, to adjust the size of the loop, and in the view shown in FIG. 1, the buckle portions 25 and 26 are slid back from the left and right front ends 20 and 21 and coupled together to cinch the waist belt 11 around the waist of the user.

The waist belt 11 is worn low on the user's body, preferably midway between the greater trochanter and the iliac crest levels. This shows a desired configuration for the harness 10 which arranges and aligns the various elements and features of the harness 10 on the user's body in a particular way to enable full functionality of the harness 10.

The left and right hip plate assemblies 12 and 13 are both connected to the waist belt 11 and extend from the waist belt 11. The left and right hip plate assemblies 12 and 13 are mirror identical: they have identical structural elements and features but are mirror opposites. As such, the same reference characters are used here to identify the same structural elements and features of the left and right hip plate assemblies 12 and 13. The reader will understand that the description of either the left or right hip plate assemblies 12 and 13 applies to both the left or right hip plate assemblies 12 and 13 equally unless specifically noted.

Referring primarily to the left hip plate assembly 13 because it is most visible in FIG. 1, the left hip plate assembly 13 includes a plate 30, a block 31 on the plate 30, and a cable connection 32 on the block 31. The left hip plate assembly 13 further includes a wide padding or pad 33 “under” or behind the plate 30.

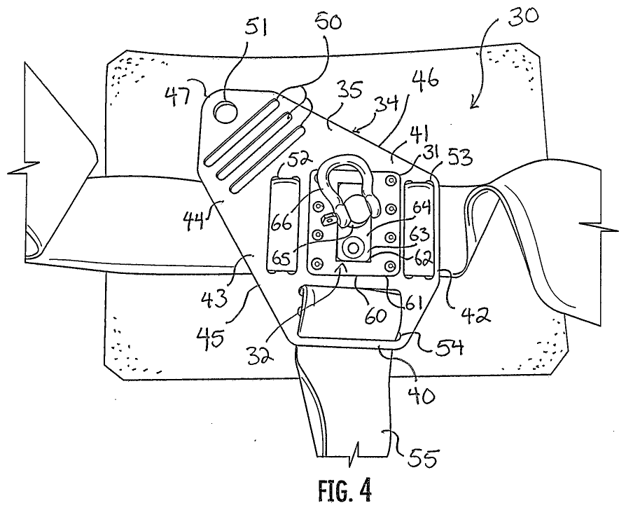

Turning to FIG. 4, the plate 30 (of the left hip plate assembly 12) has, roughly, a tear drop shape. The plate 30 is flat and relatively thin. It has an inner face 34 and an opposed outer face 35. Both the inner and outer faces 34 and 35 are flat without projections or protrusions extending out of the inner and outer faces 34 and 35. The plate 30 has a bottom 40 and a top 41, as well as a general rear 42 and a general front 43. The bottom 40, top 41, rear 42, and front 43 are defined with respect to the block 31 on the plate 30. The top 41 is defined here as a top because it is above the block 31, and similarly, the front 43 is defined here as a front because it is in front of the block 31. The bottom 40 and rear 42 are perhaps more clearly structures or locations of the plate 30, but the top 41 and front 43 are no less located on the plate 30.

A horn 44 is formed integrally to the plate 30 but also projects therefrom. The horn 44 is very roughly triangular in form. It 44 extends forwardly and upwardly from the front 43 and the top 41 of the plate 30. Two long edges 45 and 46 project forwardly and converge toward each other and toward a tip 47 of the horn 44. Between the long edges 45 and 46 are a plurality of slots 50. Here, in a non-limiting embodiment, there are three slots 50. Those slots 50 are formed entirely through the horn 44 and are oriented transverse with the respect to the bottom 40 and rear 42 of the plate 30. The slots 50 allow for an auxiliary belt to be attached to the plate 30.

The auxiliary belt can be looped through the slots 50 and then passed backward and downward, around the buttocks and over to the plate 30 on the right hip plate assembly 13. When arranged in this manner, the auxiliary belt acts as a sub-ischial support strap to assist raising the user in the event that the user falls or collapses. The auxiliary belt is especially useful when the user adopts a sitting position in the event of a fall or collapse. The slots 50 are located so that the auxiliary belt is in line with the cable connection 32 on the plate 30 to support the sit bones and buttocks during a fall or collapse.

Beyond the slots 50, between the slots 50 and the tip 47 of the horn 44, is a bore 51 formed through the plate 30. The slots 50 are located between the bore 51 and the block 31 on the plate 30. The bore 51 is an attachment point for a safety cable, such as may be necessary to help right a user who has fallen.

Around the block 31 are front slots 52, rear slots 53, and bottom slots 54. The front slots 52 are in front of the block 31, and the rear slots 53 are behind the block 31. The waist belt 11 is passed through these slots 52 and 53 to connect and locate the left hip plate assembly 12 on the waist belt 11. The left hip plate assembly 12 can be slid along the waist belt 11 by feeding the waist belt 11 through the slots 52 and 53 in a first direction or in a second direction opposite the first direction. The bottom slots 54 are below the block 31, and a vertical belt 55 is passed through those slots 54 and then extends downward to connect the left thigh sleeve assembly 14 to the left hip plate assembly 12.

The block 31 is located centrally on the plate 30 between the bottom 40, top 41, rear 42, and front 43. The block 31 is a rectangular prism base 60 projecting laterally outward from the plate 30 and having an internal cavity and a cover 61 fit over the base 60. The cover 61 has a slot 62 formed entirely thorough the cover 61. A key 63 is fit into the cavity and secured under the cover 61, projecting out through the slot 62. They key 63 can be removed from the block 31 by unscrewing bolts that secure the cover 61 to the base 60. The key 63 has a wide base captured in the cavity and a rectangular post 64 projecting through the slot 62 providing a platform to which a cylindrical post 65 is secured. A D ring 66 is mounted on the post 65. The D ring 66, post 65, post 64, key 63, slot 62, cover 61, and base 60 cooperate to form the cable connection 32 mentioned earlier. The post 65 can rotate around an axis along its length, and the D ring 66 can pivot on the post 65. The cable connection 32 is removable and can be replaced with another embodiment described below.

The cable connection 32 is the structural location on the harness 10 where the user attaches the cable connecting their harness 10 to the body weight support device for locomotion. When the harness 10 is worn as shown in FIG. 1, with the waist belt 11 worn low as pictured, each of the left and right hip plate assemblies 12 and 13 are disposed such that the cable connection is located at a mid-pelvic link point 67 (shown in broken line in FIG. 1) on the body. The mid-pelvic link point 67 is midway between the greater trochanter and the iliac crest.

The vertical belt 55 extends down from the left hip plate assembly 12 to the left thigh sleeve assembly 14. Another vertical belt 55 extends down from the right hip plate assembly 13 to the right thigh sleeve assembly 15. The left and right thigh sleeve assemblies 14 and 15 are mirror identical: they have identical structural elements and features but are mirror opposites. As such, the same reference characters are used here to identify the same structural elements and features of the left and right thigh sleeve assemblies 14 and 15. The reader will understand that the description of either the left and right thigh sleeve assemblies 14 and 15 applies to both the left and right thigh sleeve assemblies 14 and 15 equally unless specifically noted.

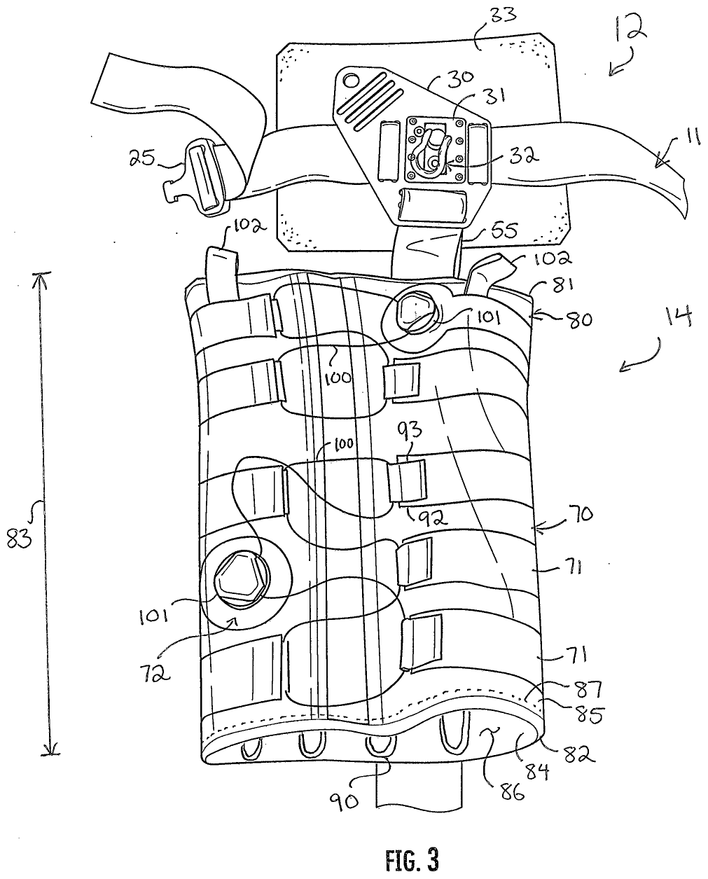

FIG. 3 illustrates the left thigh sleeve assembly 14 attached to the left hip plate assembly 12. The left thigh sleeve assembly 14 includes a sleeve 70, a plurality of segments or straps 71 on the sleeve 70, and an adjustable pulley assembly 72 on the sleeve 70. The left thigh sleeve assembly 14 distributes the weight of the user's body across a large surface area to minimize discomfort from localized pressure and prevent the occurrence of pressure and shear injury to the skin and soft tissues. The thigh sleeve assemblies 14 and 15 transmit the external force applied to the harness, and thus to the body, to the hip joint, which is a normal physiological pattern of force transmission in typical locomotion.

The sleeve 70 is a continuous piece of material formed generally into a body 80 having a top 81, an opposed bottom 82, a height 83 extending between the top 81 and bottom 82, and an inner surface 84 and opposed outer surface 85. The front half of the sleeve 70 is generally elastic and the back half of the sleeve 70 is generally inelastic, and the two halves are formed monolithically as a single, continuous sheet. The inner surface 84 bounds and defines an interior 86 extending within the sleeve 70 between the top 81 and bottom 82. Openings at the top 81 and bottom 82 allow the user to insert and pass his leg through the sleeve 70 to position it on the thigh, above the knee. The sleeve 70 is available in a few pre-defined sizes to accommodate thighs of different dimensions, and the pulley assembly 72 can then grossly or finely adjust the tightness and provide a custom fit of the sleeve 70 on a leg. The outer surface 85 of the sleeve 70 defines a circumference 87, shown in broken line in FIG. 3, which extends continuously around the outer surface 85 in a single plane parallel to the top 81 and bottom 82.

The sleeve 70 material is generally elastic along its front half. In some embodiments, the sleeve 70 is constructed from a single layer of material, while in other embodiments it is constructed from two or more layers of material or materials. The sleeve 70 can be stretched in laterally or outwardly along its circumference. The sleeve 70 has the shape of an inverted cone, but the sleeve 70 is only slightly conical, tapering just slightly from the top 81 to the bottom 82. Preferably, the user (or health care worker assisting the user) selects a size of the sleeve 70 which fits snugly on the thigh before the pulley assembly 72 is adjusted.

In preferred embodiments, the sleeve 70 has a liner attached to or defining the inner surface 84 constructed from neoprene. Moreover, in preferred embodiments, the inner surface 84 carries a silicone coating or beading to improve grip and adhesion between the inner surface 84 and the skin on the thigh. The vertical belt 55 is sewn to the inner surface 84 to couple the left thigh sleeve assembly 14 to the left hip plate assembly 12.

In some embodiments, the sleeve 70 is constructed from or includes synthetic fiber strands or wires arranged in a looped, side-by-side adjacent relationship to form an open mesh in a conical shape using a cylindrically-helically-wound braid or biaxial braid that converts axial tension force into radial compression force.

In some embodiments, the sleeve 70 incorporates a synthetic fiber cable or wire that is helically wound in contiguous loops around the circumference 87 in a first direction from the top 81 to the bottom 82 and extended in a helical wind in a second direction opposite the first direction from the bottom 82 to the top 81 with the cable or wire disposed in a tube or sheath with low surface friction to distribute the external force of the harness 10 over a large surface of the skin.

A number of straps 71 are sewn onto the outer surface 85 of the sleeve 70. These straps 71 are constructed of an inelastic material. The straps 71 have rear ends 91 and opposed front ends 92 terminating in loops 93 with upper and lower openings. Those loops 93 are or include low-friction bushings or guides for laces of the pulley assembly 72.

The straps 71 are sewn onto the outer surface 85 laterally around the circumference 87. They are spaced apart along the height 83 of the sleeve 70. As shown in FIG. 3, there are five straps 71 but this number is not critical. In other embodiments, there may be a lesser or greater number of straps 71.

The straps 71 are arranged in pairs; two straps 71 are arranged in a single row of straps. As such, one set of straps 71 is made of “inner” straps 71 and the other set of straps 71 is made of “outer” straps 71. The outer straps 71 are under the vertical belt 55 and are marked on FIG. 1 with the reference character 94, while the inner straps 71 are disposed at the level of the upper thigh below the groin and are marked on FIG. 1 with the reference character 95.

The front ends 92 of the straps 71 in a pair are directed toward each other, and the straps extend around to the rear of the sleeve 70 where they terminate at their rear ends 91.

The front ends 92 of the straps 71 in a pair are spaced apart from each other, and all the pairs are similarly spaced apart, so that the front ends 92 bound a front compression zone 96 marked with a broken line in FIG. 1. While the sleeve 70 is inelastic laterally along the portion under the straps 71 due to the inelasticity of the straps 71, the front compression zone 96 is an area of the sleeve 70 which is elastic. When the pulley assembly 72 is adjusted, the front compression zone 96 can expand or contract.

Similarly, as shown in FIG. 2, the rear ends 91 of the straps 71 in a pair are spaced apart from each other, and all the pairs are similarly spaced apart, so that the rear ends 91 bound a rear compression zone 97 marked with a broken line. The sleeve 70 is inelastic laterally along the portion under the straps 71 due to the inelasticity of the straps 71, and it is inelastic in the rear compression zone 97 due to the construction of the material of the sleeve. When the pulley assembly 72 is adjusted, the rear compression zone 97 generally maintains its size and shape and thus can loosen or tighten around the user's thigh. In some embodiments, the rear ends 91 of the straps 71 are the locations at which the straps 71 are sewn into the sleeve 70 itself, where the straps 71 move just under the outer surface 85. In those embodiments, the outer straps 94 actually preferably extend continuously around the back of the sleeve 70 to the inner straps 95, such that each row includes only a single strap 71. In this embodiment, the rear compression zone 97 is inelastic.

The front compression zone 96 is a vertical portion of the sleeve 70 which maintains elasticity, while the rear compression zone 97, on an opposed side of the sleeve, is a vertical portion of the sleeve 70 which maintains inelasticity, along with the two portions of the sleeve 70 under the inner and outer straps 95 and 94. In some embodiments of the thigh sleeve assemblies 14 and 15, the rear compression zone 97 includes several parallel zippers that can be coupled to each other to alter the size of the sleeve 70.

The contour or fit of the sleeve 70 is adjustable using the pulley assembly 72. The pulley assembly 72 on each sleeve 70 includes two long laces 100 and two reel dials 101. One of the laces 100 is passed through the loops 93 on the top four straps 71. As shown in FIG. 3, only three of the front ends 92 are fit with the loops 93 because the top-most strap 71 of the inner straps 95 has one of the reel dials 101 mounted to it instead of a loop 93. The lace 100 is passed through these loops 93, criss-crossing across the front compression zone 96, and then engages with the reel dial 101. Adjusting the reel dial selectively loosens and tightens the lace 100, loosening or constricting the sleeve 70 near the top 81.

Similarly, the other of the laces 100 is passed through the loops 93 on the bottom six straps 71. As shown in FIG. 3, only five of the front ends 92 are fit with the loops 93 because the middle strap 71 of the outer straps 94 has one of the reel dials 101 mounted to it instead of a loop 93. The lace 100 is passed through these loops 93, criss-crossing across the front compression zone 96, and then engages with that reel dial 101. Adjusting that reel dial selectively loosens and tightens the lace 100, loosening or constricting the sleeve 70 near the bottom 82.

To assist in donning the sleeve 70, inelastic pull loops 102 are sewn to the uppermost straps 71 of both the outer and inner straps 94 and 95. These pull loops 102 project above the top 81 of the sleeve 70. When the user is putting the sleeve 70 on, he can grab these straps 94 and 95 and pull the sleeve 70 upward.

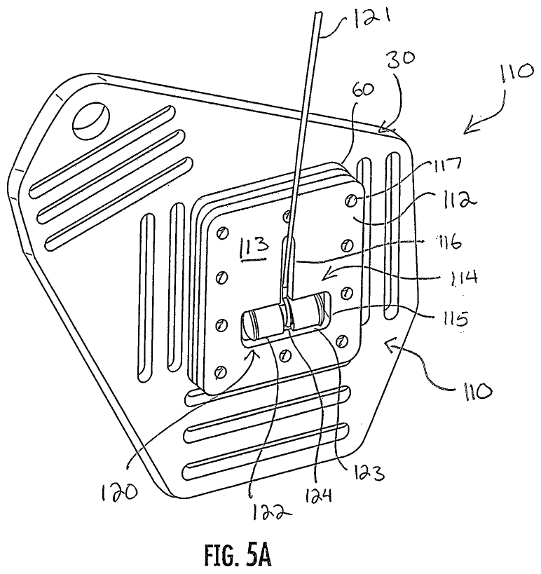

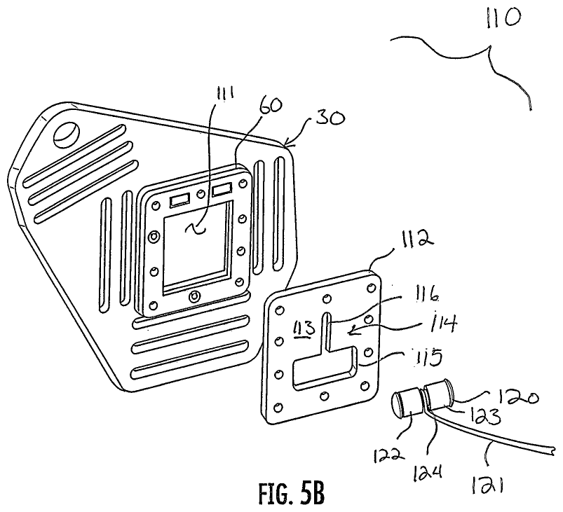

One embodiment of the harness has been described which uses the cable connection 32 shown in FIGS. 1-4. FIGS. 5A and 5B show an alternate embodiment, however, marked with the reference character 110. FIG. 5A is a perspective view, and FIG. 5B is an exploded perspective view.

The cable connection 110 includes the base 60 mounted on the plate 30, both already described. Here it can be seen that the base 60 has a cavity 111. The cavity 111 is a rectangular prismatic space or hold. It is bound and defined by the four walls of the base 60 on all sides, by the plate 30 at one end, and by a cover 112 at the opposed end.

The cover 112 is a flat, thin plate having an inner surface and opposed outer surface 113. A T-shaped slot 114 is formed entirely through the cover 112 from the inner surface to the outer surface 113. The slot 114 has a large horizontal base 115 and a slender vertical slit 116 extending normal to the base 115 and projecting from the center of the base 115. The slit 116 is much thinner in dimension than is the base 115.

The cover 112 is coextensive to the base 60 and fits against it in registered alignment. Screws 117, bolts, or other fasteners secure the cover 112 to the base 60 along a pattern of threaded holes formed in the base 60. When so secured, the cover 112 well defines the cavity 111 inside the cable connection 110.

That cavity 111 retains a chock 120 on the end of a cable 121. The cable 121 extends from the chock 120 to the body weight support device for locomotion. The cable 121 connects the harness—and thus the user—to the device during rehabilitation. There are two hip plate assemblies 12 and 13 and thus two plates 30 and two cavities 111, and there are two cables 121, each extending to one of the chocks 120 for securing with one of the cavities 111, respectively.

The chock 120 has a cylindrical body formed with two opposed lobes 122 and 123 spaced apart by a hub 124. The lobes 122 and 123 are cylindrical and coextensive with each other and are larger than the cylindrical hub 124. The cable 121 is attached to the chock 120 at the hub 124; it may be wound around, looped, or tied onto the hub 124. When so coupled, the chock 120 can be moved into the cavity 111 to secure the cable 121 to the plate 30.

The base 115 of the T-shaped slot 114 is just slightly larger than the chock 120. The user passes the chock 120—with the cable 121 coupled thereto—through the base 115 and into the cavity 111. The user then pulls the cable 121 up so that the chock 120 moves upward within the cavity 111 and the cable 121 threads through the slit 116 of the T-shaped slot 114. When the user puts the harness 10 on and begins rehabilitative work, there is a load on the cable 121 which keeps the cable 121 taught, and pulls the chock 120 upwardly within the cavity 111. However, because the base 115 of the T-shaped slot 114 is at the bottom, pulling on the chock 120 cannot inadvertently pull the chock 120 out of the cavity 111. As such, the chock 120 remains coupled to the plate 30.

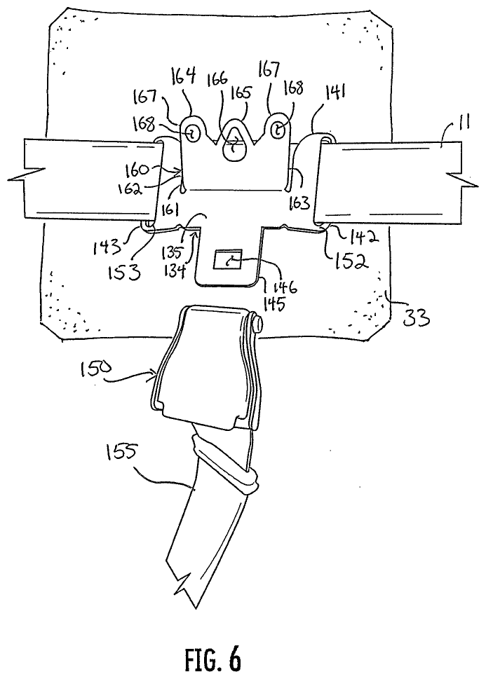

Another embodiment of a hip plate is shown in FIG. 6 and marked with reference character 130. The plate 130 has, roughly, a T shape. It has an inner face 134 and an opposed outer face 135. The inner face 134 is adhered or otherwise secured to the pad 33. Like the plate 30, the plate 130 has a bottom 140 and a top 141, as well as a general rear 142 and front 143. A tongue 145 extends downwardly from the bottom 140. The tongue 145 has a roughly rectangular shape with a through-hole 146 formed centrally therein. The tongue 145 securely and removably receives a clasp buckle 150 which is attached to a vertical belt 155. The vertical belt 155 extends downward to the left thigh sleeve assembly 14, similarly to the belt 55. The clasp buckle 150 can be secured to the tongue 145 and thus to the plate 130, thereby securely coupling left thigh sleeve assembly 14 to the plate 130 in a strong and durable fashion.

There are slots on the plate 130 that allow the plate 130 to fit onto the waist belt 11. There is a rear slot 152 at the rear 142 of the plate 130 and a front slot 153 at the front 143 of the plate 130. The waist belt 11 is passed through these two slots 152 and 153 to connect and locate the plate 130 on the waist belt 11. When the plate 130 is used, it creates a different embodiment of the left hip plate assembly 12, but one which can still be slid along the waist belt 11 by feeding the waist belt 11 through the slots 152 and 153 in a first direction or a second direction opposite the first direction.

The plate 130 additionally includes a crown 160 extending from the center of the plate 130. The crown 160 has a base 161 formed integrally and monolithically to the plate 130, two opposed sides 162 and 163 which are separated from the plate 130, and a serrated top 164. At the center of the top 164 is a triangular projection 165 with a tear-drop shaped bore 166 formed entirely through the crown 160. This bore 166 is a cable connection for attaching a cable from a body weight support device to the plate 130. On both sides of the triangular projection 165, two projections extend upward from the base 161 to define fingers 167 on either side of the projection 165. These fingers 167 are formed with bores 168. The bores 168 are useful as connection points for safety cables.

In operation, the user dons the harness 10 by passing his left leg into the sleeve 70 of the left thigh sleeve assembly 14 and his right leg into the sleeve 70 of the right thigh sleeve assembly 15, possibly using the pull loops 102 to assist in pulling the sleeves 70 up and over his thigh. He then wraps the waist belt 11 around his pelvis, buckling the left and right buckle portions 25 and 26. He then adjusts the left and right hip assemblies 12 and 13 so that each is located over a respective mid-pelvic link point 67 and tightens the waist belt 11. This places the harness 10 in a desired configuration, which arranges and aligns the various elements and features of the harness 10 on the user's body to enable full functionality of the harness 10. The user then tightens the pulley assemblies 72 on each of the left and right thigh sleeve assemblies 14 and 15 so that the sleeves 70 are snug on the thighs.

The rear compression zone 97 and the portions of sleeve 70 under the outer and inner straps 94 and 95 are inelastic, and so those areas constrict around the thigh. The front compression zone 96 is under the pulley assembly 72 and thus cannot expand, so it is also functionally inelastic when the pulley assembly 72 is so tightened, and so it also constricts around the thigh. Lastly, and usually with the help of a health worker, he attaches cables from the body weight support device to the cable connection 32 or to the cable connection 110, or to triangular projection 165, depending on the embodiment of the harness 10 used. The harness is now ready for use.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A harness comprising:
an inelastic waist belt having a rear, a left side, an opposed right side, and opposed left and right front ends configured to couple to each other;
first and second hip plate assemblies connected to the waist belt and extending therefrom, wherein each of the first and second hip plate assemblies includes:
a plate, the plate having a front and an opposed rear, and a top and an opposed bottom;
a block located centrally on the plate between the front, rear, top, and bottom; and
a cable connection on the block;
first and second thigh sleeve assemblies connected to the first and second hip plate assemblies, respectively, and extending therefrom.

2. The harness of claim 1, wherein each of the first and second hip plate assemblies includes:
a projecting horn extending forwardly and upwardly from the front and top of the plate; and
the horn including a plurality of slots spaced apart from each other.

3. The harness of claim 2, wherein the plurality of slots on the horn are formed entirely through the horn and are oriented transverse with respect to the rear and bottom of the plate.

4. The harness of claim 2, wherein the horn further includes a bore formed through the plate, and the slots are located between the bore and the block on the plate.

5. The harness of claim 1, wherein each of the first and second hip plate assemblies further includes padding carried on an inner face of the plate.

6. The harness of claim 1, wherein each of the first and second hip plate assemblies are located on the waist belt such that, when the harness is worn in a desired configuration, the cable connection is located at a mid-pelvic link point.

7. The harness of claim 1, wherein the cable connection is removable from the block.

8. A harness comprising:
an inelastic waist belt having a rear, a left side, an opposed right side, and opposed left and right front ends configured to couple to each other;
first and second hip plate assemblies connected to the waist belt and extending therefrom; and
first and second thigh sleeve assemblies connected to the first and second hip plate assemblies, respectively, and extending therefrom, wherein each of the first and second thigh sleeve assemblies includes:
a continuous sleeve constructed of inelastic and elastic material having a height and a circumference;
a plurality of inelastic segments spaced apart along the height of the sleeve; and
an adjustable pulley assembly carried on the sleeve and threaded among the inelastic segments.

9. The harness of claim 8, wherein the inelastic segments are straps of inelastic material sewn to the sleeve laterally around the circumference.

10. The harness of claim 9, wherein the inelastic segments extend less than entirely around the circumference, terminating at a vertical portion of the sleeve which maintains inelasticity.

11. The harness of claim 8, wherein the inelastic segments terminate at front ends in loops, and a cable of the adjustable pulley assembly is threaded through each of the loops.

12. The harness of claim 8, further comprising inelastic loops coupled to an uppermost of the inelastic segments and projecting above a top of the sleeve.

13. A harness comprising:
an inelastic waist belt having a rear, a left side, an opposed right side, and opposed left and right front ends configured to couple to each other;
first and second hip plate assemblies connected to the waist belt and extending therefrom, wherein each of the first and second hip plate assemblies includes:
a plate, the plate having a front and an opposed rear, a top and an opposed bottom, a front slot at the front, a rear slot at the rear, and a bottom slot at the bottom;
a block located centrally on the plate between the front, rear, top, and bottom; and
a cable connection on the block;
first and second thigh sleeve assemblies connected to the first and second hip plate assemblies, respectively, and extending therefrom, wherein each of the first and second thigh sleeve assemblies includes:
a continuous sleeve constructed of inelastic and elastic material having a height and a circumference;
a plurality of inelastic segments spaced apart along the height of the sleeve; and
an adjustable pulley assembly carried on the sleeve and threaded among the inelastic segments;
wherein the waist belt passes through the front and rear slots of the first and second hip plate assemblies, a first vertical belt couples the first hip plate assembly to the first thigh sleeve assembly, and a second vertical belt couples the second hip plate assembly to the second thigh sleeve assembly.

14. The harness of claim 13, wherein each of the first and second hip plate assemblies includes:
a projecting horn extending forwardly and upwardly from the front and top of the plate; and
the horn including a plurality of slots spaced apart from each other.

15. The harness of claim 14, wherein the plurality of slots on the horn are formed entirely through the horn and are oriented transverse with respect to the rear and bottom of the plate.

16. The harness of claim 14, wherein the horn further includes a bore formed through the plate, and the slots are located between the bore and the block on the plate.

17. The harness of claim 13, wherein each of the first and second hip plate assemblies are located on the waist belt such that, when the harness is worn in a desired configuration, the cable connection is located at a mid-pelvic link point.

18. The harness of claim 13, wherein the inelastic segments are straps of inelastic material sewn to the sleeve laterally around the circumference.

19. The harness of claim 18, wherein the inelastic segments extend less than entirely around the circumference, terminating at a vertical portion of the sleeve which maintains inelasticity.

20. The harness of claim 13, further comprising inelastic loops coupled to an uppermost of the inelastic segments and projecting above a top of the sleeve.
